(19) United States
(12) Patent Application Publication
(10) Pub. No.: US 2026/0211617 A1
(43) Pub. Date: Jul. 23, 2026

(54) MULTIPLYING TWO WIDE-WORD INTEGER VALUES

(71) Applicant: International Business Machines Corporation, Armonk, NY (US)

(72) Inventors: Silvia Melitta Mueller, St. Ingbert (DE); Manoj Kumar, Yorktown Heights, NY (US); DEBAPRIYA CHATTERJEE, Austin, TX (US); Thomas Szabo, Stuttgart (DE); Daniel Fallnich, Stuttgart (DE)

(21) Appl. No.: 19/066,680

(22) Filed: Feb. 28, 2025

(30) Foreign Application Priority Data
Jan. 23, 2025 (GB) 2500944.0

(51) Int. Cl. G06F 7/491

(52) U.S. Cl. CPC G06F 7/4915

(57) ABSTRACT

A computer implemented method of multiplying two wide-word integer values, the method comprising: multiplying two or more limbs of a first integer value with two or more limbs of a second integer value to create one or more partial products; summing one or more partial products of a same radix value resulting in one or more partial sums, wherein the one or more partial sums are stored in a target vector register; indicating by an additional operand, opcode, immediate or another register, which of the one or more partial products participate in forming the one or more partial sums; performing all of the above steps by a single instruction in a computer hardware circuit.

The present invention relates in general to a computer implemented method of multiplying two wide-word integer values and a computer hardware circuit for execution of at least one instruction for performing the method.

### BACKGROUND

Computers perform integer arithmetic on integers that can be represented in few tens of bits. The largest number of bits on which a typical computer performs integer arithmetic, w, is typically 8, 16, 32 or 64. The quantity w is also referred to as word size. Computers also store multiple integers in a vector register and can perform arithmetic operations on these multiple integers simultaneously. These vector registers are v-bit wide, v is typically 128, 256 or 512. Thus a 128-bit vector register can hold two 64-bit integers or four 32-bit integers.

Cryptographic applications perform arithmetic on n-bit integers where n is much larger than the vector register size v or the largest integer representation w. For example, the RSA (Rivest-Shamir-Adleman) algorithms perform arithmetic on few thousand-bit integers, while ECC (Elliptic Curve Cryptography) algorithms perform arithmetic on few-hundred-bit integers. In the future, FHE (Fully Homomorphic Encryption) algorithms will also perform arithmetic on hundred to thousand-bit wide integers. These n-bit integers, n>w, will be referred to as wide integers. These cryptographic applications are bedrock of secure communication in networking (TLS, SSH, SHTTP, etc.), cryptocurrency, smart cards, and many others. ECC has gained widespread use because of its favorable performance/security trade-offs compared to RSA. ECC is also central to adoption of PQC (Post Quantum Cryptography) as it will be deployed in hybrid mode of PQC by early adopters of PQC.

The term ‘elliptic curve cryptography’ (ECC) may denote an approach to public-key cryptography based on the algebraic structure of elliptic curves over finite fields. ECC allows smaller keys compared to non-EC cryptography (e.g., based on plain finite fields) to provide equivalent security. Typically, elliptic curves are applicable for key agreement, digital signatures, pseudo-random generators, block chains and other tasks. Indirectly, elliptic curves can be used for encryption by combining the key agreement with a symmetric encryption scheme. In the context of this document, elliptic curves are mainly used in conjunction with mathematically hard problems to solve in absence of some secret information, which has many applications in cryptography.

Multiplication of two large integers, C=(A×B) mod N, is a common and time-consuming operation in cryptography. So is the square function, C=A² mod N, which occurs frequently in ECC. Current state of the art is to break the large n-bit integers A and B into w-bit components, multiply each component of A with all components of B, to form partial products, and then sum the partial products of similar radix. Hereby w is the largest word size on which computer arithmetic is performed. Each summing operation can potentially result in an overflow, which must be checked, and then accounted for by adding the overflow in the higher-radix word. This checking of and accounting for the overflow slows down the speed of large integer multiplies significantly.

US 2023/0142818 A1 discloses an accelerator circuit that performs a wide integer modular multiply in an iterative fashion. The accelerator circuit is limited to a modular multiply process. The accelerator circuit is further limited to primes of the form 2N -m where N and m are integer numbers. The scheme requires that the operands are partitioned into limbs in a certain way defined by (N, m).

US 2023/0273770 A1 describes an accelerator circuit/method that performs the wide integer modular multiply in an iterative fashion on a multiplication circuitry and a reduction circuitry. The circuit/method is limited to a modular multiply process.

US 2017/0187529 A1 discloses a scheme how to compute modular multiplication with wide integers using a dedicated multiplication device. The described device contains a multiplier without any of the optimizations introduced by our invention. The scheme provides a set of SIMD instructions, that describe how wide integer arithmetic operations can be performed, when the integers are in limb-format.

### SUMMARY

A computer implemented method of multiplying two wide-word integer values represented in a Reduced-Radix Representation using a Redundant Number System arithmetic is proposed, wherein each integer value is stored in a set of source vector registers as two or more limbs per vector register, the method comprising: multiplying two or more limbs of the first integer value with two or more limbs of the second integer value to create one or more partial products; summing one or more partial products of a same radix value resulting in one or more partial sums, wherein the one or more partial sums are stored in a target vector register; indicating by an additional operand, opcode, immediate or another register, which of the one or more partial products participate in forming the one or more partial sums; performing all of the above steps by a single instruction in a computer hardware circuit.

Further, a computer implemented method of multiplying two wide-word integer values represented in a Reduced-Radix Representation using a Redundant Number System arithmetic is proposed, wherein each integer value is stored in a set of source vector registers as two or more limbs per vector register, the method comprising: multiplying two or more limbs of the first integer value with two or more limbs of the second integer value to create one or more partial products; summing the one or more of the partial products of a same radix value resulting in one or more partial sums, wherein the one or more partial sums thus formed are stored in a target vector register; indicating by an additional operand, opcode, immediate or another register, which of the one or more partial products are doubled before being summed up with another one of the one or more partial products of the same radix value; representing a product of the multiply process as sums of the partial sums; performing all of the above steps by a single instruction in a computer hardware circuit.

Further, a computer implemented method of multiplying two wide-word integer values represented in a non-Reduced-Radix Representation is proposed, wherein successive subsets of bits of a binary representation of a wide integer are stored in different source vector registers, the method comprising: multiplying all words of the first integer value obtained from a first source vector register with corresponding words of the second integer value obtained from a second source vector register to create one or more partial products; shifting the one or more of the partial products to align a radix value; adding the shifted partial products to a result; storing the result, the result being up to two vector registers wide, in two target vector registers; performing all of the above steps by one instruction or by two instructions, a first instruction to store a first part of the result in a first target vector register and a second instruction to store a second part of the result in a second target vector register.

Further, a computer hardware circuit for execution of at least one instruction for performing the method of multiplying two wide-word integer values represented in a Reduced-Radix Representation using a Redundant Number System arithmetic is proposed, at least comprising source vector registers for input of two wide integer values and an addend, two multiplier units adapted for computation of at least two partial products, two adder units adapted for adding the partial products and the addend, four multiplexer units adapted for implementing shifts of partial sums and the addend, two adder units adapted for computing a sum, and a target vector register for storing the sum.

Further, a computer hardware circuit for execution of at least one instruction for performing the method of multiplying two wide integer values represented in a non-Reduced-Radix Representation is proposed, at least comprising source vector registers for input of two wide-word integer values and an addend, two multiplier units adapted for computation of at least two partial products, two adder units adapted for adding the partial products and the addend, a multiplexer unit adapted for selecting a low part of the result, two adder units adapted for computing the result and carry bits, a gating function and a multiplexer unit adapted for selecting the result and carry bits, a target vector register for storing the result.

### BRIEF DESCRIPTION OF THE SEVERAL VIEWS OF THE DRAWINGS

The present invention together with the above-mentioned and other objects and advantages may best be understood from the following detailed description of the embodiments, but not restricted to the embodiments.

FIG. 1 depicts a method of multiplying two wide integer values according to prior art.

FIG. 2 depicts a wide-word integer value in a Reduced-Radix Representation.

FIG. 3 depicts partial sums of a process of multiplying two wide-word integer values represented in a Reduced-Radix Representation using a Redundant Number System arithmetic.

FIG. 4 depicts an overview of the process of multiplying two wide-word integer values represented in a Reduced-Radix Representation using a Redundant Number System arithmetic.

FIG. 5 depicts vector registers holding two limbs of two wide integer values each according to an embodiment of the invention.

FIG. 6 depicts a detailed view of computing a partial sum from the input integer values according to FIG. 5.

FIG. 7 depicts an overview of the process of squaring a wide-word integer value represented in a Reduced-Radix Representation using a Redundant Number System arithmetic according to an embodiment of the invention.

FIG. 8 depicts a computer hardware circuit for execution of at least one instruction for performing the method of multiplying two wide-word integer values represented in a Reduced-Radix Representation using a Redundant Number System arithmetic according to a further embodiment of the invention.

FIG. 9 depicts inputs for combining partial sums into sums according to a further embodiment of the invention.

FIG. 10 depicts an operation of combining partial sums into sums according to an embodiment of the invention.

FIG. 11 depicts three vector registers with sums using the limb based Redundant Number System.

FIG. 12 depicts rebasing the sums of FIG. 11 according to an embodiment of the invention.

FIG. 13 depicts a result of the rebasing process according to FIG. 12.

FIG. 14 depicts operational semantics of a method of multiplying two wide-word integer values represented in a non-Reduced-Radix Representation according to a further embodiment of the invention.

FIG. 15 depicts a computer hardware circuit for execution of at least one instruction for performing the method of multiplying two wide-word integer values represented in a non-Reduced-Radix Representation according to a further embodiment of the invention.

### DETAILED DESCRIPTION

A computer implemented method of multiplying two wide-word integer values represented in a Reduced-Radix Representation using a Redundant Number System arithmetic is proposed, wherein each integer value is stored in a set of source vector registers as two or more limbs per vector register, the method comprising: multiplying two or more limbs of the first integer value with two or more limbs of the second integer value to create one or more partial products; summing one or more partial products of a same radix value resulting in one or more partial sums, wherein the one or more partial sums are stored in a target vector register; indicating by an additional operand, opcode, immediate or another register, which of the one or more partial products participate in forming the one or more partial sums; performing all of the above steps by a single instruction in a computer hardware circuit.

Reduced-Radix Representation (RRR) and Redundant Number System (RNS) arithmetic is an often-used approach to substantially eliminate the accounting of carries mentioned above.

The term ‘reduced-radix form’ or ‘reduced radix representation’ may denote the known number format in computer science allowing faster algorithmic operations of binary numbers.

The proposed method eliminates overhead of checking for and accounting for carries by representing wide integers in Reduced-Radix Representation (RRR) and Redundant Number System (RNS) and using a set of instructions supported by a dedicated computer hardware circuit to perform the RNS arithmetic to multiply two wide integers.

Summing of the partial products formed from multiplication of RRR/RNS numbers requires shifting the partial products to align the radix values. The proposed instructions incorporate the shift needed to align the radixes. Thus, the need to check for and account for overflows on every addition performed is avoided, and does not incur the usual shift instruction penalty of the RRR/RNS approach.

The proposed method provides for add-with-shift instructions, along with supporting computer hardware circuits, to shift the partial sums obtained from multiplication of wide integers represented in RRR, before these partial sums are added together to get the sum as in standard multiplication according to state of the art. This shift is required to align the radix values, and by using the add-with-shift instruction an extra rotate/shift instruction is avoided.

The method also provides for rebase instructions that align the carry of each word with the next higher-significance limb and perform the addition.

In short, the proposed method provides an instruction-set extension to make use of dedicated computer hardware circuit for multiplying two wide-word integer values represented in a Reduced-Radix Representation using a Redundant Number System arithmetic.

In an additional or alternative embodiment of the invention, further comprising: indicating by an additional operand, opcode, immediate or another register, which of the one or more partial products are doubled before being summed up with another one of the one or more partial products of the same radix value. Considering the whole bitstring of machine code to be the opcode an immediate in this sense is part of an instruction opcode for performing aspects of the multiply operation. Thus, partial product computation may be optimized.

In an additional or alternative embodiment of the invention, the one or more partial products may be selectively doubled and/or disabled before being summed up. Thus, partial products may be computed and added via an immediate.

In an additional or alternative embodiment of the invention, the one or more partial products or an addend may be selectively doubled before being summed up. Thus, partial products and an addend may be computed and added via an immediate.

In an additional or alternative embodiment of the invention, the one or more partial products may comprise a first partial product and a second partial product, wherein the first partial product or the addend may be selectively doubled, wherein the second partial product may be disabled before being summed up. Favorably, a partial product may be computed and an addend added via an immediate.

In an additional or alternative embodiment of the invention, the one or more partial sums may be formed by summing the one or more partial products of the same radix value being stored in a set of target vector registers, the method further comprising: extracting different subsets of bits of the two or more partial sums; shifting the extracted subsets of bits to align the radix values; adding the shifted extracted subsets of bits to produce a sum which is then stored in a target vector register; computing the partial sums by a single instruction in the computer hardware circuit. Thus, partial sums may be combined into sums in an efficient way.

In an additional or alternative embodiment of the invention, three partial sums may be merged into at least one sum, wherein two partial sums may be merged into the highest radix sums and lowest radix sums each. Thus, partial sums may be combined into sums in an efficient way.

In an additional or alternative embodiment of the invention, two of the three partial sums may be shifted in the target vector register for aligning the radix values. Thus, merging the limbs into the sums may be performed in an efficient way.

Further, a computer implemented method of multiplying two wide-word integer values represented in a Reduced-Radix Representation using a Redundant Number System arithmetic is proposed, wherein each integer value is stored in a set of source vector registers as two or more limbs per vector register, the method comprising: multiplying two or more limbs of the first integer value with two or more limbs of the second integer value to create one or more partial products; summing the one or more of the partial products of a same radix value resulting in one or more partial sums, wherein the one or more partial sums thus formed are stored in a target vector register; indicating by an additional operand, opcode, immediate or another register, which of the one or more partial products are doubled before being summed up with another one of the one or more partial products of the same radix value; representing a product of the multiply process as sums of the partial sums; performing all of the above steps by a single instruction in a computer hardware circuit.

The proposed method eliminates overhead of checking for and accounting for carries by representing wide integers in Reduced-Radix Representation (RRR) and Redundant Number System (RNS) and using a set of instructions supported by a dedicated computer hardware circuit to perform the RNS arithmetic to multiply two wide integers.

Summing of the partial products formed from multiplication of RRR/RNS numbers requires shifting the partial products to align the radix values. The proposed instructions incorporate the shift needed to align the radixes. Thus, the need to check for and account for overflows on every addition performed is avoided, and does not incur the usual shift instruction penalty of the RRR/RNS approach.

The proposed method provides for add-with-shift instructions, along with supporting computer hardware circuits, to shift the partial sums obtained from multiplication of wide integers represented in RRR, before these partial sums are added together to get the sum as in standard multiplication according to state of the art. This shift is required to align the radix values, and by using the add-with-shift instruction an extra rotate/shift instruction is avoided.

The method also provides for rebase instructions that align the carry of each word with the next higher-significance limb and perform the addition.

In an additional or alternative embodiment of the invention, the one or more partial products may be selectively doubled and/or disabled before being summed up. Thus, partial product computation may be controlled by an immediate.

In an additional or alternative embodiment of the invention, the one or more partial products or an addend may be selectively doubled before being summed up. Thus, partial product and an addend computation may be controlled by an immediate.

In an additional or alternative embodiment of the invention, the one or more partial products may comprise a first partial product and a second partial product, wherein the first partial product or the addend may be selectively doubled, wherein the second partial product may be disabled before being summed up. Favorably, a partial product may be computed and an addend added via an immediate.

In an additional or alternative embodiment of the invention, sums may be rebased by adding high order bits to a next higher radix limb when too many carry bits are accumulated. Thus, a fewer number of carry bits may occur in the sums of the multiply process.

In an additional or alternative embodiment of the invention, rebasing the sums may be combined with addition and/or reduction operations. Thus, multiple rebase variants may allow to combine multiple operation for performing wide integer arithmetic efficiently.

In an additional or alternative embodiment of the invention, at least one of the one or more partial products may be scaled by a factor of two. The scaling provides significant performance advantage for squaring large integers by eliminating redundant product computations.

Further, a computer implemented method of multiplying two wide-word integer values represented in a non-Reduced-Radix Representation is proposed, wherein successive subsets of bits of a binary representation of a wide integer are stored in different source vector registers, the method comprising: multiplying all words of the first integer value obtained from a first source vector register with corresponding words of the second integer value obtained from a second source vector register to create one or more partial products; shifting the one or more of the partial products to align a radix value; adding the shifted partial products to a result; storing the result, the result being up to two vector registers wide, in two target vector registers; performing all of the above steps by one instruction or by two instructions, a first instruction to store a first part of the result in a first target vector register and a second instruction to store a second part of the result in a second target vector register.

The proposed method for scaling of wide integers may favorably be used for the scaling of one wide integer value with another, smaller, integer value that can be represented using a single double-word and being held in a single vector element.

For some operations non-RRR is more efficient than RRR. Examples of such situations are modular reduction for primes P255-19 and 256k1 and modular inversion with new block GCD (Greatest Common Divisor) algorithm. Overhead is incurred in non-RRR arithmetic in shifting the two partial products formed by element-wise multiplication of e.g. two 64-bit numbers in each of two vectors registers to align the radixes of the partial products, before these partial products can be added.

The proposed method eliminates overhead of checking for and accounting for carries.

Summing of the partial products requires shifting the partial products to align the radix values. The proposed instructions incorporate the shift needed to align the radixes. Thus, the need to check for and account for overflows on every addition performed is avoided.

An additional aspect of the proposed method eliminates the overheads incurred in non-RRR arithmetic by summing these partial products after shifting by the desired 64-bits.

In an additional or alternative embodiment of the invention, further comprising: multiplying all words of the first integer value obtained from the first source vector register with a corresponding word of the second integer value obtained from the second source vector register to create the one or more partial products; shifting the one or more of the partial products to align the radix value; adding the shifted partial products to the result; storing the result, the result being up to two vector registers wide, in two target vector registers; performing all of the above steps by one instruction or by two instructions, the first instruction to store the first part of the result in the first target vector register and the second instruction to store the second part of the result in the second target vector register.

Thus, the multiply process of two wide-word integer values represented in a non-Reduced-Radix Representation may be performed in a particularly efficient way.

In an additional or alternative embodiment of the invention, an addend for adding to the product of the two wide-word integer values may be enabled by an immediate bit. Thus, adding the addend may be implemented in the scaling operation of two partial products.

Further, a computer hardware circuit for execution of at least one instruction for performing the method of multiplying two wide-word integer values represented in a Reduced-Radix Representation using a Redundant Number System arithmetic is proposed, at least comprising source vector registers for input of two wide integer values and an addend, two multiplier units adapted for computation of at least two partial products, two adder units adapted for adding the partial products and the addend, four multiplexer units adapted for implementing shifts of partial sums and the addend, two adder units adapted for computing a sum, and a target vector register for storing the sum.

The proposed computer hardware circuit is adapted for implementation of partial sum instructions in order to perform the method of multiplying two wide-word integer values represented in a Reduced-Radix Representation using a Redundant Number System arithmetic described above.

The computer hardware circuit comprises at least two multiplier units for partial product computation, adder units to sum partial products and an addend, as well as multiplexer units to implement shifts of partial products in order to perform the multiply process in an efficient way.

In an additional or alternative embodiment of the invention, the computation of the partial products and the addition of the addend may be split into high parts and low parts. Implementation of partial sum instructions for multiplying two wide-word integer values represented in a Reduced-Radix Representation using a Redundant Number System arithmetic may be particularly efficient by this way.

In an additional or alternative embodiment of the invention, two multiplexer units of the four multiplexer units for shifting the addend may be fed by a low addend part of the addend and a high addend part of the addend, the two multiplexer units being coupled to the two adder units and the other two multiplexer units of the four multiplexer units may be coupled between the two adder units for adding the partial products and the addend and the two adder units for computing the sum. Implementation of partial sum instructions for multiplying two wide-word integer values represented in a Reduced-Radix Representation using a Redundant Number System arithmetic may be particularly efficient by this way.

Further, a computer hardware circuit for execution of at least one instruction for performing the method of multiplying two wide integer values represented in a non-Reduced-Radix Representation is proposed, at least comprising source vector registers for input of two wide-word integer values and an addend, two multiplier units adapted for computation of at least two partial products, two adder units adapted for adding the partial products and the addend, a multiplexer unit adapted for selecting a low part of the result, two adder units adapted for computing the result and carry bits, a gating function and a multiplexer unit adapted for selecting the result and carry bits, a target vector register for storing the result.

The proposed computer hardware circuit is adapted for implementation of wide integer multiply instructions in order to perform the method of multiplying two wide integer values represented in a non-Reduced-Radix Representation described above.

The computer hardware circuit comprises at least two multiplier units for partial product computation, adder units to sum partial products and an addend, as well as multiplexer units to implement shifts of partial products and to select sum and/or carry parts in order to perform the multiply process in an efficient way.

In an additional or alternative embodiment of the invention, the computation of the partial products and the addition of the addend may be split into high parts and low parts. Implementation of wide integer multiply instructions for multiplying two wide-word integer values represented in a non-Reduced-Radix Representation may be particularly efficient by this way.

In an additional or alternative embodiment of the invention, the gating function and the multiplexer for selecting the result and carry bits may be coupled between the two adder units for computing the result and carry bits and a target vector register. Sum and/or carry parts may be selected accordingly in an efficient way.

In the drawings, like elements are referred to with equal reference numerals. The drawings are merely schematic representations, not intended to portray specific parameters of the invention. Moreover, the drawings are intended to depict only typical embodiments of the invention and therefore should not be considered as limiting the scope of the invention.

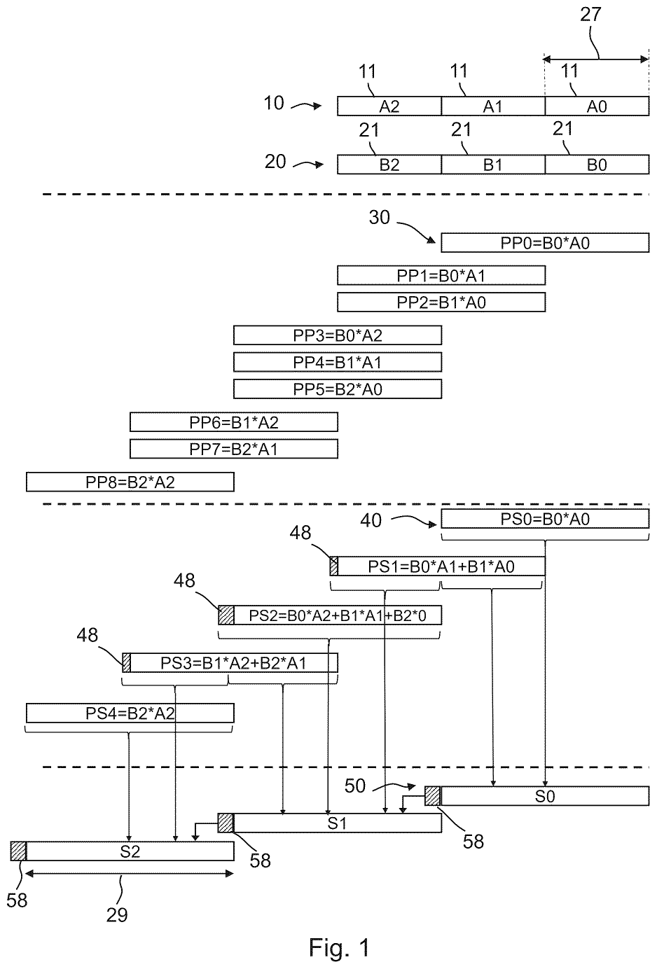

FIG. 1 depicts a method of multiplying two wide integer values 10, 20 according to prior art.

Multiplication of two wide integers 10, 20, S=(A×B) mod N, where A and B are the integer values 10, 20, S is the product and N is an integer modulus, is a common and time-consuming operation in cryptography. So is the square function, S=A² mod N, which occurs frequently in ECC. Current state of the art is to break the large n-bit integers A and B into w-bit components or words 11, multiply each component 11 of A with all components 21 of B, as shown in FIG. 1, to form partial products 30, and then sum the partial products 30 of similar radix into partial sums 40 which are then summed to sums 50. Recall w is a word size 27 on which computer arithmetic is performed. Each summing operation can potentially result in an overflow, which must be checked, and then accounted for by adding the overflow in the higher-radix word 11. This checking of and accounting for the overflow slows down the speed of large integer multiplies significantly.

In the example, shown in FIG. 1, the two large integer values 10, 20 of a length of e.g. 192 bits, named A and B are represented each as three words 11, named A0, A1, A2, and B0, B1, B2 with an element size 27 of 64 bits. Their multiplication produces nine partial product terms 30, named PP0 to PP8. Partial products 30 of equal radix are first added to create five partial sums 40, named PS0 to PS4. Odd-index partial products 30 are split, shifted and added to even-indexed term to obtain the sums 50, named S0, S1, S2.

Hereby each addition operation can result in an overflow. Possible overflow 48 for partial product addition as well as possible overflow 58 for partial sum addition is marked in the Figure.

So the program to perform the multiply operation needs extra instructions to manage an overflow after each addition. This slows the speed of large integer multiply operations.

Partial products 30 are PP0=B0*A0 at a first radix value, PP1=B0*A1 and PP2=B1*A0 at another radix value, PP3=B0*A2, PP4=B1*A1 and PP5=B2*A0 at a further radix value, PP6=B1*A2, PP7=B2*A1 at another radix value and PP8=B2*A2 at a further radix value.

Partial sums 40 are accordingly PS0=B0*A0, PS1=B0*A1+B1*A0, PS2=B0*A2+B1*A1+B2*0, PS3=B1*A2+B2*A1 and PS4=B2*A2 for the different radix values.

Sums 50 are accordingly S0 from PS0 and PS1, S1 from PS1, PS2 and PS3, and S2 from PS3 and PS4. The widths of the sums 50 are of double element size 29 which may be 128 bits.

The proposed method of multiplying two wide-word integer values 10, 20 represented in a Reduced-Radix Representation using a Redundant Number System arithmetic, wherein each integer value 10, 20 is stored in a set of source vector registers 60, 61, 62, 63 as two or more limbs 12 per vector register 60, 61, 62, 63, comprises: multiplying two or more limbs 12 of a first integer value 10 with two or more limbs 22 of a second integer value 20 to create one or more partial products 30; summing one or more partial products 30 of a same radix value resulting in one or more partial sums 40, wherein the one or more partial sums 40 are stored in a target vector register 64, 66; indicating by an additional operand, opcode, immediate or another register, which of the one or more partial products 30 participate in forming the one or more partial sums 40. A product of the multiply process is represented as sums 50 of the partial sums 40.

Favorably computing partial sums is performed by a single instruction and computing sums is performed by another single instruction.

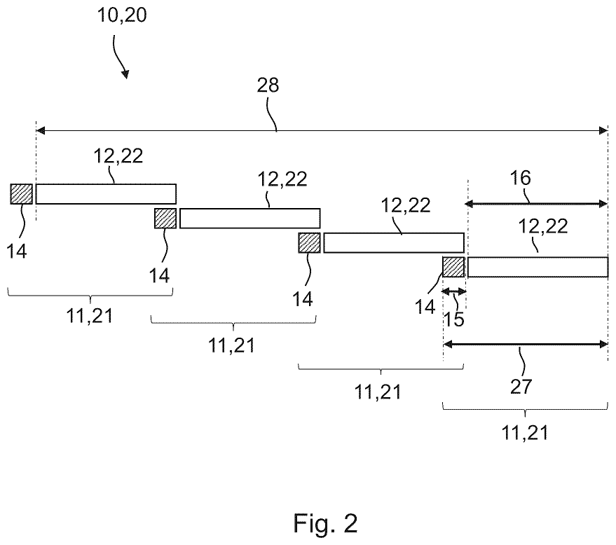

An outline of the proposed method is explained in FIGS. 2 to 4, where a representation of large integers 10, 20 in Reduced-Radix Representation (RRR) and their multiplication is illustrated.

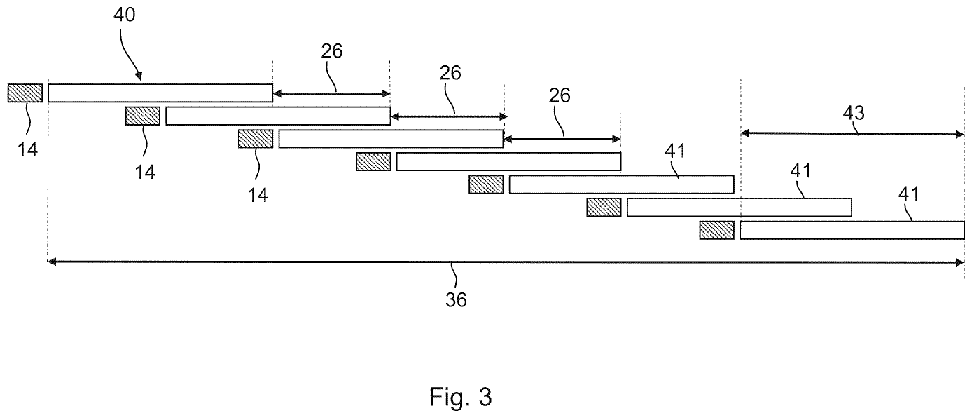

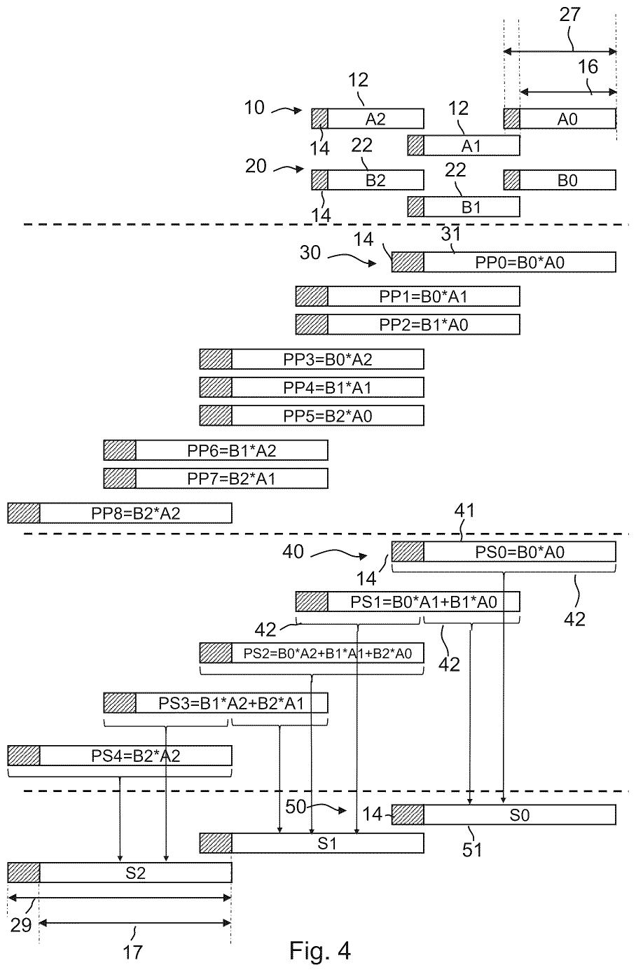

FIG. 2 depicts a wide-word integer value 10, 20 in a Reduced-Radix Representation. FIG. 3 depicts partial sums of a process of multiplying two wide integer values represented in a Reduced-Radix Representation using a Redundant Number System arithmetic whereas in FIG. 4 an overview of the process of multiplying two wide integer values represented in a Reduced-Radix Representation using a Redundant Number System arithmetic according to an embodiment of the invention is depicted.

In RRR, an n-bit wide integer value 10, 20 is represented as a number of w-bit words 11, 21, where w is the element size 27, e.g. 64 bits. Each word 11, 21 is storing ls bits as limbs 12, 22 of the wide integer 10, 20, where ls is the limb size 16, e.g. 56 bits. The remaining w-ls bits of each word 11, 21 will be referred to as the carry bits 14, e.g. with a carry bit size 15 of 8 bits.

Carry bits 14 are represented in the Figures as hashed areas to be distinguishable from other elements.

Multiplication is performed on two ls-bit limbs 12, 22 of each multiplicand, and the two partial products 30 are added. Two enable bits exclude or include either of the partial products 30 in the sum 40 and two scale bits double the value of the corresponding partial product 30. The scaling capability is useful in squaring of wide integers 10, 20 where partial products 30 are doubled.

In FIG. 2 the integer size 28 may be 224 bits, whereas an element size 27 may be 64 bits. The limb size 16, which may be variable, may be 56 bits. The carry bit size 15 of the carry bits 14 may be 8 bits.

So only 56 bits in each input word 11, 21 of 64 bits may be used for multiplication, whereas the remaining 8 bits are a carry into the next word 11, 21.

So each partial product 30 may be 112 bits plus a 16 bit carry 14.

The partial sums 40 in FIG. 3 may exhibit limbs 41 with a double limb size 43 of 112 bits (as is double the single limb size 16) as the corresponding partial products 30 are doubled. The limb offset 26 may be 56 bits and the carry bits 14 may be 16 bits wide.

It should be mentioned, that a design can pick any pair of limb size 16 and double limb size 43, it does not have to be 56 bits and 112 bits.

The size 15 of the carry bits 14 in input integer values 10, 20 is bounded so that the carry bits 14 in the partial sums 40 or sums 50 do not overflow.

FIG. 4 depicts an exemplary multiply carpet with multiplier 10 and multiplicand 20 represented as three words 11, 21 with an element size 27 of 64 bits each, using three limbs 12, 22 with a limb size 16 of e.g. 56 bits each, the partial products 30 represented using three limbs with double the limb size 16. The sums 50 as well as the partial sums 40 have a double element size 29 of e.g. 128 bits, and a double limb size 17 of 112 bits. The length of the carry bits 14 may be 16 bits.

Reference numerals of words 11, 21, limbs 12, 22 of input integer values 10, 20, limbs 31 of partial products 30, limbs 41 of partial sums 40, limbs 51 of sums 50 and carry bits 14 are only marked for some elements for reason of clarity.

The integer values 10, 20 are represented as limbs 12, A0, A1, A2 and single word 21, B0, B1, B2 of element size 27 which may be 64 bits.

Partial products 30 are PP0=B0*A0 at a first radix value, PP1=B0*A1 and PP2=B1*A0 at another radix value, PP3=B0*A2, PP4=B1*A1 and PP5=B2*A0 at a further radix value, PP6=B1*A2, PP7=B2*A1 at another radix value and PP8=B2*A2 at a further radix value.

Partial sums 40 are accordingly PS0=B0*A0, PS1=B0*A1+B1*A0, PS2=B0*A2+B1*A1+B2*0, PS3=B1*A2+B2*A1 and PS4=B2*A2 for the different radix values.

Sums 50 are accordingly S0 from PS0 and PS1, S1 from PS1, PS2 and Ps3, and S2 from PS3 and PS4.

The proposed method provides for add-with-shift instructions, to shift the partial sums 40 obtained from multiplication of the wide integers 10, 20 represented in RRR, before these partial sums 40 are added together to get the sum 50 as in standard multiplication according to state of the art. This shift is required to align the radix values, and by using the add-with-shift instruction an extra rotate/shift instruction is avoided.

Accumulated carry bits 14 have to be added to limbs of next higher radix. In FIG. 4, limb A1, B1 have a lower radix value than limbs A2, B2. Furthermore, rebase operations are not used directly in multiply-multiply-add operations but rather associated with additional operations following the wide integer multiply operation.

The proposed method accelerates execution of multiplication and squaring on wide integer values 10, 20 through hardware enhancements to a conventional CPU core such as POWER processor. The method also uses a set of vector instructions to surface this hardware capability.

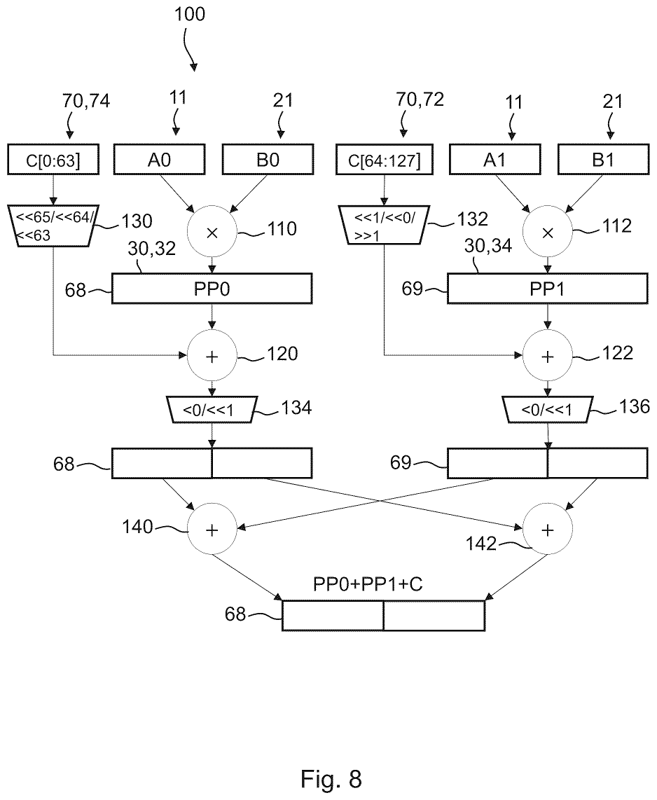

The hardware enhancements are computer hardware circuits (see FIG. 8) to execute sequences of elementary operations such as shift, multiply and add, as a single instruction on vector registers 60, 61, 62, 63, which occur frequently in multiplication of RRR/RNS wide integer values 10, 20.

In an instruction according to an embodiment element-wise multiplication on two 64-bit double words 11, 21 of integer values 10, 20 of operands A and B is performed, and the resulting two partial products 30 summed up. The differentiating component of this instruction from the prior art is the use of immediate operands to enable the inclusion of the partial products 30 and scaling either or both partial products 30 by a factor of two. The scaling provides significant performance advantage for squaring large integers by eliminating redundant product computations. The ‘enable’ feature eliminates extract operations for edges of multiply carpet. The computer hardware circuit 100 to implement above instructions is shown in FIG. 8.

As may be seen from FIG. 4, the one or more partial sums 40 are formed by summing the one or more partial products 30 of the same radix value, the partial sums 40 then being stored in a set of target vector registers 64, 66. For this purpose the method further comprises: extracting different subsets of bits 42 of the two or more partial sums 40; shifting the extracted subsets of bits 42 to align the radix values; and adding the shifted extracted subsets of bits 42 to produce a sum 50 which is then stored in a target vector register 64, 66.

Computing partial sums 40 may be performed by a single instruction and computing sums 50 may be performed by another single instruction.

Three partial sums 40 may be merged into at least one sum 50, wherein two partial sums 40 are merged into the highest radix sums 44 and lowest radix sums 46 each. Further, two of the three partial sums 40 may be shifted in the target vector register 64, 66 for aligning the radix values.

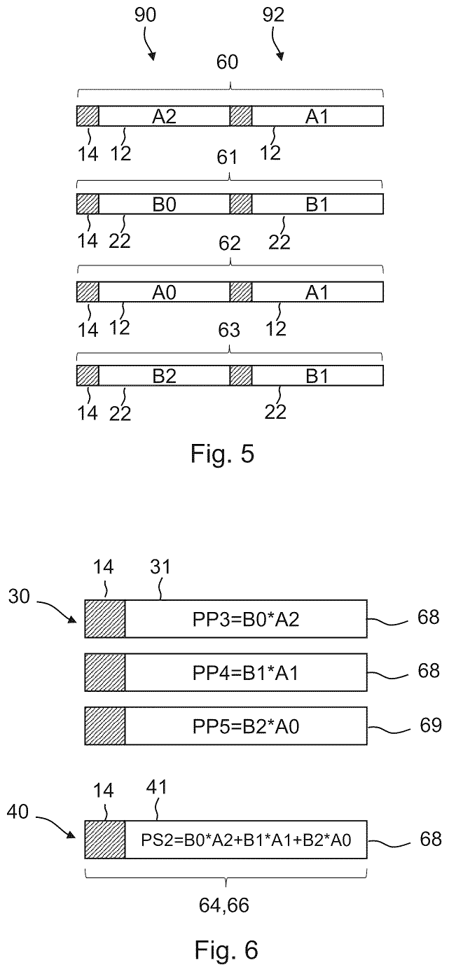

FIG. 5 depicts vector registers 60, 61, 62, 63 each holding two limbs 12, 22 of two wide-word integer values 10, 20 each according to an embodiment of the invention. The vector register 60 with a width of e.g. 128 bits holds a right limb 12, A1, and a left limb 12, A2. The limb size may be 56 bits and the size of the carry bits 8 bits each. Correspondingly the vector register 61 holds the two limbs 22, B0 and B1, the vector register 62 the two limbs 12, A0 and A1, and the vector register 63 the two limbs 22, B2 and B1.

FIG. 6 depicts a detailed view of computing a partial sum 40 from the input integer values 10, 20 according to FIG. 5.

Normal multiply-multiply-add vector instruction computes a sum of two products where the products are a product of two left limbs 12, 22 of a vector register 60, 61, 62, 63 and a product of two right limbs 12, 22 of the vector register 60, 61, 62, 63. As shown in FIG. 6, partial products 30 may be PP3=B0*A2, PP4=B1*A1 and PP5=B2*A0 resulting in a partial sum 40 PS2=B0*A2+B1*A1+B2*A0. The partial products PP3, PP4, PP5 may be stored as intermediate results 68, 69 whereas the partial sum PS2 as an intermediate result 68 may be stored in a target vector register 64, 66.

If a partial sum 40 consists of an odd number of partial products, one multiply-multiply-add instruction must compute only one partial product. Normally that requires an additional instruction to extract single limbs 12, 22 from the vector register 60, 61, 62, 63. The proposed method allows to disable partial products 30 and thus eliminates additional instructions.

For optimizations for partial product computation and squaring of RRR represented integer values 10, 20 it may be indicated by an additional operand, opcode, immediate or another register, which of the one or more partial products 30 are doubled before being summed up with another one of the one or more partial products 30 of the same radix value.

In one instruction the one or more partial products 30 may be selectively doubled and/or disabled before being summed up.

In another instruction the one or more partial products 30 or an addend 70 may be selectively doubled before being summed up.

In a further instruction the one or more partial products 30 may comprise a first partial product 32 and a second partial product 34, wherein the first partial product 32 or the addend 70 may be selectively doubled, wherein the second partial product 34 may be disabled before being summed up. First and second partial products 32, 34 are marked in the computer hardware circuit 100 in FIG. 8.

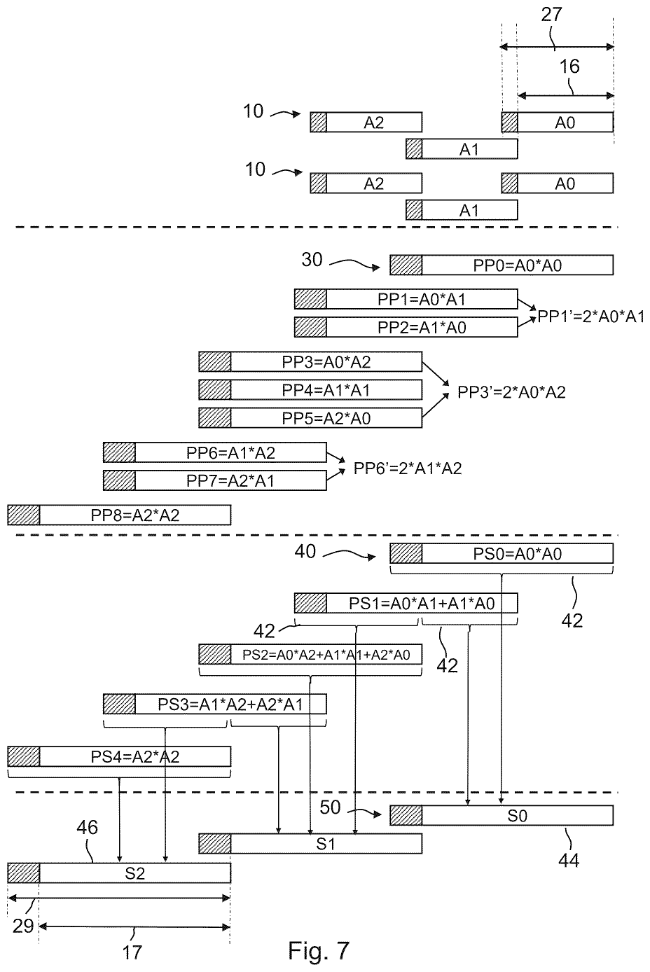

FIG. 7 depicts an overview of the process of squaring a wide-word integer value 10 represented in a Reduced-Radix Representation using a Redundant Number System arithmetic according to an embodiment of the invention.

This scheme resembles the scheme shown in FIG. 4 except that the second integer value 20 is replaced by the first integer value 10.

During squaring, several partial products 30 have to be computed twice (PP2, PP5, PP7). The proposed method allows to only compute these partial products 30 once and double them directly in the associated instruction, thus eliminating all instructions associated with the computation of the second partial product 30. This is indicated in the Figure. Thus, the partial products 30 PP1′, which is 2*A0*A1, PP3′, which is 2*A0*A2 and PP6′, which is 2*A1*A2 are computed.

FIG. 8 depicts a computer hardware circuit 100 for execution of at least one instruction for performing the method of multiplying two wide-word integer values 10, 20 represented in a Reduced-Radix Representation using a Redundant Number System arithmetic according to a further embodiment of the invention. The circuit 100, shown in FIG. 8 computes multiply-multiply-add instructions for RRR wide integers. The circuit 100 only computes partial sums 40. Partial sums 40 are combined to sums 50 using shift-and-add instructions implemented in a circuit that is not shown in the Figure. Input in vector elements are A0, A1 as words 11 of a first integer value 10, B0, B1 as words 21 of a second integer value 20 as well as C as an addend 70 with a low addend part 72 and a high addend part 74.

The computer hardware circuit 100 comprises source vector registers 60, 61, 62, 63 for input of two wide-word integer values 10, 20 and an addend 70. Two multiplier units 110, 112 are adapted for computation of at least two partial products 30. A first partial product 32, PP0, is computed from the vector elements A0, B0 and a second partial product 34, PP1, is computed from the vector elements A1, B1. Two adder units 120, 122 are adapted for adding the partial products 30 and the addend 70. Four multiplexer units 130, 132, 134, 136 are adapted for implementing shifts of partial partial products 32, 34 and the addend 70, respectively. The adders 120, 122 in the circuit 100 are used to combine the (possibly shifted) partial products 32, 34, PP0, PP1, with the addend 70.

The computation of the partial products 30 and the addition of the addend 70 may be split into high parts 90 and low parts 92 as is shown with the instructions depicted in FIGS. 5 and 6.

Two multiplexer units 130, 132 of the four multiplexer units 130, 132, 134, 136 for shifting the addend 70 may be fed by a low addend part 72 of the addend 70 and a high addend part 74 of the addend 70, whereas the two multiplexer units 130, 132 may be coupled to the two adder units 120, 122. The multiplexer units 130 may perform shifts of 65 bits, 64 bits and 63 bits to the left, respectively (indicated by <<65/<<64/<<63). The multiplexer unit 132 may perform shifts of 1 bit or 0 bit to the left and 1 bit to the right, respectively (indicated by <<1/<<0/>>1). Implementation of this circuit 100 also has the capability of saving the shifted out bit for the case of shifting right by 1, in order to later add it to the word for the case where the multiplexer 132 shifts right by 1 and the following multiplexer 136 shifts left by 1.

The other two multiplexer units 134, 136 of the four multiplexer units 130, 132, 134, 136 may be coupled between the two adder units 120, 122 for adding the partial products 30 and the addend 70 and the two adder units 140, 144 for computing the sum PP0+PP1+C. Partial products 32, 34 as well as the result PP0+PP1+C are stored temporarily as intermediate results 68, 69.

According to a further embodiment the method may further comprise multiplying two or more limbs 12 of a first integer value 10 with two or more limbs 22 of a second integer value 20 to create one or more partial products 30; summing the one or more of the partial products 30 of a same radix value resulting in one or more partial sums 40, wherein the one or more partial sums 40 thus formed are stored in a target vector register 64, 66; indicating by an additional operand, opcode, immediate or another register, which of the one or more partial products 30 are doubled before being summed up with another one of the one or more partial products 30 of the same radix value; and representing a product of the multiply process as sums 50 of the partial sums 40. Computing partial sums 40 may be performed by a single instruction and computing sums 50 may be performed by another single instruction. The last step of the method, combining partial sums 40 to sums 50 is not performed in the same instruction as the multiplication but rather using additional shift-and-add instructions. While it would be theoretically possible to perform all the steps in a single instruction, at least the circuit 100 shown in FIG. 8 is not capable of implementing all steps in a single instruction.

The one or more partial products 30 may be selectively doubled and/or disabled before being summed up.

The one or more partial products 30 or an addend 70 may be selectively doubled before being summed up.

The one or more partial products 30 may comprise the first partial product 32 and the second partial product 34, wherein the first partial product 32 or the addend 70 may be selectively doubled, wherein the second partial product 34 may be disabled before being summed up.

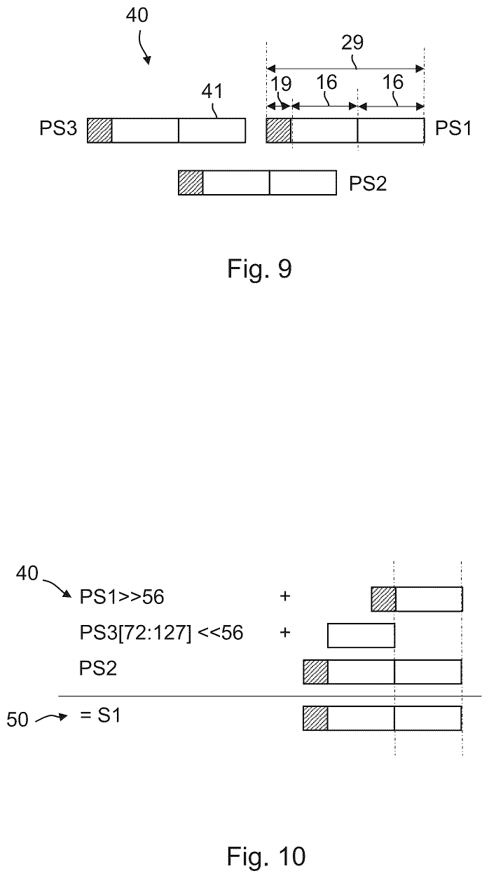

FIG. 9 depicts inputs for combining partial sums 40 into sums 50 according to a further embodiment of the invention.

An instruction according to a further embodiment performs a three-input add operation to reduce the partial-sums 40 to sums 50, as illustrated in FIG. 9. Inputs are partial sums 40, PS1, PS2, PS3. The partial sums 40 have limbs 41 of double the limb size 16 of the input integer values 10, 20 which may be 112 bits and a double carry bit size 19 of 16 bits. The partial sums 40, PS1, PS2, PS3, are double element size 29, e.g. 128 bits wide.

As is shown in FIG. 10, which depicts an operation of combining the partial sums 40 into sums 50, two of these three inputs PS1, PS2, PS3 may be shifted by the single limb size 16 of 56 bits for aligning the radix values. The highest-radix and the lowest-radix sums 50 require addition of only two partial sums 40.

The first partial sum PS1 is shifted to the right by 56 bits (indicated by >>56) and added to the higher part of the third partial sum with bits 72 to 127 which is shifted by 56 bits to the left (indicated by <<56). The result is added to the second partial sum PS2 resulting in the sum S1.

According to a further embodiment the carry bits 14, the 16 high bits of partial sums 40 or sums 50 are taken, and added to contents of 112 low order bits or all 128 bits of the second input integer value 20. The 112 low order bits or all 128 bits of an additional addend 70 may be allowed to be added. Non-carry bits, bits [16:127] of the sum 50 or partial sum 40 may be taken and added to the non-carry bits or all bits of the second input integer value 20.

According to an embodiment the one or more partial sums 30 may be rebased by adding high order bits 24 to a next higher radix limb 12 when too many carry bits 14 are accumulated. Rebasing the one or more partial sums 30 may be combined with addition and/or reduction operations. At least one of the one or more partial products 30 may be scaled by a factor of two.

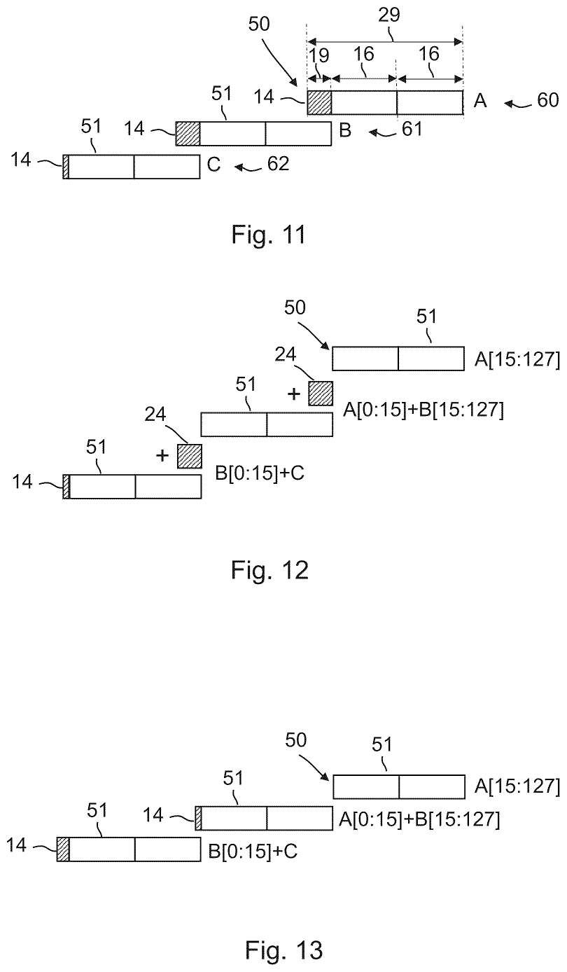

FIG. 11 depicts three vector registers 60, 61, 62 with sums 50 using the limb based Redundant Number System. The sums 50 have limbs 51 of double the limb size 16 of the input integer values 10, 20 which may be 112 bits and a double carry bit size 19 of 16 bits. The sums 50 are double element size 29, e.g. 128 bits, wide.

16-bit of the carry bit 14, the high order 16 bits of the 128-bit vector registers 60, 61, 62 are accumulated over several instructions of earlier two groups. To prevent the 16-bit carry bit 14 from overflowing, these high order bits 24 are added to the next higher radix limb 51 as illustrated in FIG. 12, when too many carry bits 14 have accumulated. A total rebase would zero out the carry bits 14 but would require execution the rebase instruction sequentially from right to left on all vector registers 60, 61, 62 storing the limbs 51 of a wide word. A partial rebase allows rebasing to be performed out in parallel but allows for carry bits 14 to reappear as a result of rebasing, as shown in FIG. 13. However, the number of reappearing carry bits 14 is much smaller than the original number of carry bits 14.

According to a further embodiment the overheads incurred in non-Reduced-Radix Representation arithmetic may be eliminated by summing the partial products 30 after shifting by the desired 64 bits.

For the proposed method of multiplying two wide-word integer values 10, 20 represented in the non-Reduced-Radix Representation, successive subsets of bits of a binary representation of a wide integer 10, 20 are stored in different source vector registers 60, 61. The method comprises: multiplying all words 11 of a first integer value 10 obtained from a first source vector register 60 with corresponding words 21 of a second integer value 20 obtained from a second source vector register 61 to create one or more partial products 30; shifting the one or more of the partial products 30 to align a radix value; adding the shifted partial products 30 to a result 80; and storing the result 80, the result 80 being up to two vector registers wide, in two target vector registers 64, 66. All of the above steps are performed by one instruction or by two instructions, a first instruction to store a first part 82 of the result 80 in a first target vector register 64 and a second instruction to store a second part 84 of the result 80 in a second target vector register 66.

The proposed method for scaling of wide integers 10, 20 may favorably be used for the scaling of one wide integer value 10 with another, smaller, integer value 20 that can be represented using a single double-word and being held in a single vector element.

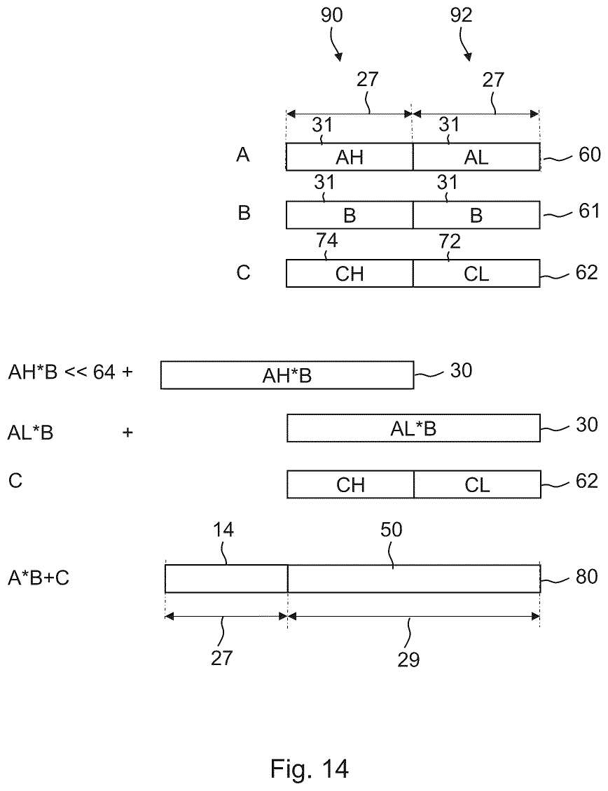

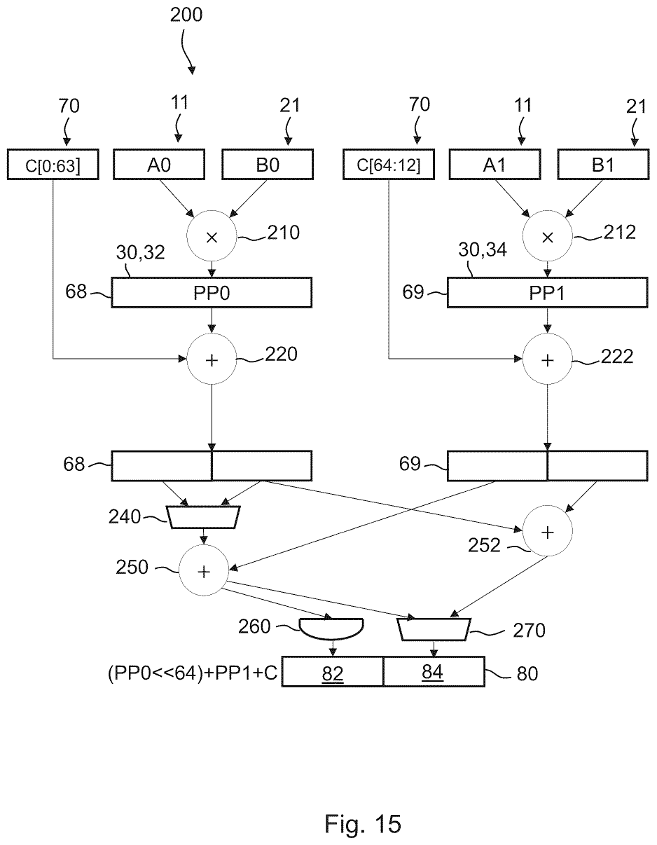

As is depicted in FIG. 14 and in FIG. 15, respectively, the method may further comprise: multiplying all words 11 of the first integer value 10 obtained from the first source vector register 60 with corresponding words 21 of the second integer value 20 obtained from the second source vector register 61 to create the one or more partial products 30; shifting the one or more of the partial products 30 in the target vector registers 64, 66 to align the radix value; adding the shifted partial products 30 to the result 80; and storing the result 80, the result 80 being up to two vector registers wide, in two target vector registers 64, 66. All of the above steps may be performed by one instruction or by two instructions, the first instruction to store the first part 82 of the result 80 in the first target vector register 64 and the second instruction to store the second part 84 of the result 80 in the second target vector register 66.

An addend 70 for adding to the product of the two wide integer values 10, 20 may be enabled by an immediate bit. While the addend 70 can be used to add an additional number to the wide integer product held in several vector registers 60, 61, 62, also a plain wide integer multiply with no additional wide addend would require addends for the vector elements for carry handling. Instead of describing addends in the wide integer context (referring to several vector registers 60, 61, 62) it may be beneficial to describe addends on the vector element level (e.g. 64 bit).

Instructions may subsume the shift operation needed to align the radixes of the two partial products 30 formed by the element-wise multiplication of two 64-bit numbers in each of two vector registers 60, 61, before these partial products 30 can be added. FIG. 14 illustrates the operational semantics of the instruction which performs the operation A×B+C. Here A and B are both vector registers 60, 61 with integer values 10, 20 holding two operands with an element size of e.g. 64 bit, their shifted partial product 30 is added to a third addend 70 and the 128 least significant bit of the result placed in a fourth vector register 64. The computer hardware circuit 200 to implement this instruction is shown in FIG. 15. Another instruction may be used to capture the bits that overflow the least 128 bits. Along with a third instruction this set may enable scaling unsigned 128b integer by unsigned 64-bit integer. It is emphasized that a distinction may be made between the operation and hardware implementation. The desired operation for the non-RRR multiply-multiply-add instructions is to multiply a 128-bit integer represented by two 64-bit vector elements by a 64-bit integer. This is implemented by storing the 128-bit integer A in a vector register 60 as two vector elements and the integer B in a vector register 61, where both 64-bit elements of the vector register hold the same 64-bit integer value B.

The first source vector register 60, A, comprises the first integer value 10, with the high part 90, AH, and the low part 92, AL. The second source vector register 61, B, holds two copies of the second integer value 20. The third source vector register 62, C, comprises the addend 70, with the high addend part 90, CH, and the low addend part 92, CL.

The high part 90 of the first integer value 10, AH, is multiplied with the second integer value 20, B, which is doubled in the vector register 61. The product is shifted by 64 bits to the left (indicated by <<64). The low part 92 of the first integer value 10, AL, is multiplied with the second integer value 20, B. The two products are added to the high part 90 and the low part 92 of the addend 70, CH, CL. The resulting sum 50 may be stored as a result 80. The sum 50 has a double element size length 29 of e.g. 128 bits and the carry bits 14 have a length of the element size 27, e.g. 64 bits.

Partial products 30 as well as the sum A*B+C may be stored as intermediate computation results 68 temporarily.

FIG. 15 depicts a computer hardware circuit 200 for execution of at least one instruction for performing the method of multiplying two wide-word integer values 10, 20 represented in a non-Reduced-Radix Representation according to a further embodiment of the invention. Input in vector elements are A0, A1 as words 11 of a first integer value 10, B0, B1 as words 21 of a second integer value 20 as well as C as an addend 70 with a low addend part 72 and a high addend part 74.

The computer hardware circuit 200 comprises source vector registers 60, 61, 62, 63 for input of word 11, 21 and an addend 70. Two multiplier units 210, 212 are adapted for computation of at least two partial products 30. Two adder units 220, 222 are adapted for adding the partial products 30, PP0, PP1, and the addend 70. A multiplexer unit 240 is adapted for selecting a first high part 82 of the result 80. Two adder units 250, 252 are adapted for computing the result 80 and carry bits 14. A gating function 260 and a multiplexer unit 270 are adapted for selecting the result 80 and carry bits 14. A target vector register 64 is adapted for storing the result 80 as a high part 82 and a second low part 84.

The computation of the partial products 30 and the addition of the addend 70 may be split into high parts 90 and low parts 92 as shown in FIG. 14.

The gating function 260 and the multiplexer 270 for selecting the result 68 and carry bits 14 may be coupled between the two adder units 250, 252 for computing the result 68 and carry bits 14 and a target vector register 64.

Intermediate results 68, 69 may be used for storing partial products 32, 34 as intermediate computation results temporarily.

According to embodiments of the invention limb sizes of 56 bits and 112 bits may be chosen. However, a design can pick any pair of limbs sizes ls and 2*ls, it does not have to be (56 bits, 112 bits).

As described above, a first embodiment of the invention are multiply/multiply-add instructions for the limb-based wide integer arithmetic support. A second embodiment of the invention are shift-mask-add instructions for the limb-based wide integer arithmetic support.

Both embodiments have a similar background about limb arithmetic, and reduced radix format, and how to do multiplications and additions in such a format.

The first embodiment may put the details in special SIMD instructions for multiplication for these applications by highlighting easy mapping on SIMD integer multiply hardware; multiplying just on the same SIMD elements (not A0*B1), because that saves multiplexing and wire congestion on the multiplier operands; having scaling, and masking and when the result exceeds the SIMD element (e.g 128b), the high or low part can be stored for the scaling instruction.

The second embodiment, after a common introduction part, may put in the details on special SIMD instructions for the shift-mask-add part by highlighting easy mapping into a wide SIMD adder block resulting in low hardware cost and very low delay of computation. There may be no generic shift and/or permute for each operand feeding on addition.

### REFERENCE NUMERALS

10 wide integer
11 word
12 limb
14 carry bits
15 carry bits size
16 limb size
17 double limb size
19 double carry bit size
20 wide integer
21 word
22 limb
24 high order bits
26 limb offset
27 element size
28 wide integer size
29 double element size
30 partial product
31 limb
32 first partial product
34 second partial product
36 partial sum size
40 partial sum
41 limb
42 subset of bits
43 double limb size
44 lowest radix sum
46 highest radix sum
48 possible overflow
50 sum
51 limb
58 possible overflow
60 source vector register
61 source vector register
62 source vector register
63 source vector register
64 target vector register
66 target vector register
68 intermediate result
69 intermediate result
70 addend
72 low addend part
74 high addend part
80 result
82 first part of the result
84 second part of the result
90 high part
92 low part
100 computer hardware circuit
110 multiplier unit
112 multiplier unit
120 adder unit
122 adder unit
130 multiplexer unit
132 multiplexer unit
134 multiplexer unit
136 multiplexer unit
140 adder unit
142 adder unit
200 computer hardware circuit
210 multiplier unit
212 multiplier unit
220 adder unit
222 adder unit
240 multiplexer unit
250 adder unit
252 adder unit
260 gating function
270 multiplexer unit

1. A computer implemented method of multiplying two wide-word integer values represented in a Reduced-Radix Representation using a Redundant Number System arithmetic, wherein each integer value is stored in a set of source vector registers as two or more limbs per vector register, the method comprising:
multiplying two or more limbs of the first integer value with two or more limbs of the second integer value to create one or more partial products;
summing one or more partial products of a same radix value resulting in one or more partial sums, wherein the one or more partial sums are stored in a target vector register;
indicating by an additional operand, opcode, immediate or another register, which of the one or more partial products participate in forming the one or more partial sums;
performing all of the above steps by a single instruction in a computer hardware circuit.

2. The method according to claim 1, further comprising:
indicating by an additional operand, opcode, immediate or another register, which of the one or more partial products are doubled before being summed up with another one of the one or more partial products of the same radix value.

3. The method according to claim 1, wherein the one or more partial products are selectively doubled and/or disabled before being summed up.

4. The method according to claim 1, wherein the one or more partial products or an addend are selectively doubled before being summed up.

5. The method according to claim 1, wherein the one or more partial products comprise a first partial product and a second partial product, wherein the first partial product or an addend are selectively doubled, wherein the second partial product is disabled before being summed up.

6. The method according to claim 1, wherein the one or more partial sums are formed by summing the one or more partial products of the same radix value being stored in a set of target vector registers, the method further comprising:
extracting different subsets of bits of the two or more partial sums;
shifting the extracted subsets of bits to align the radix values;
adding the shifted extracted subsets of bits to produce a sum which is then stored in a target vector register;
computing the partial sums by a single instruction in the computer hardware circuit.

7. The method according to claim 6, wherein three partial sums are merged into at least one sum, wherein two partial sums are merged into the highest radix sums and lowest radix sums each.

8. The method according to claim 7, wherein two of the three partial sums are shifted in the target vector register for aligning the radix values.

9. A computer implemented method of multiplying two wide-word integer values represented in a Reduced-Radix Representation using a Redundant Number System arithmetic, wherein each integer value is stored in a set of source vector registers as two or more limbs per vector register, the method comprising:
multiplying two or more limbs of the first integer value with two or more limbs of the second integer value to create one or more partial products;
summing the one or more of the partial products of a same radix value resulting in one or more partial sums, wherein the one or more partial sums thus formed are stored in a target vector register;
indicating by an additional operand, opcode, immediate or another register, which of the one or more partial products are doubled before being summed up with another one of the one or more partial products of the same radix value;
performing all of the above steps by a single instruction in a computer hardware circuit.

10. The method according to claim 9, wherein the one or more partial products are selectively doubled and/or disabled before being summed up.

11. The method according to claim 9, wherein the one or more partial products or an addend are selectively doubled before being summed up.

12. The method according to claim 9, wherein the one or more partial products comprise a first partial product and a second partial product, wherein the first partial product or an addend are selectively doubled, wherein the second partial product is disabled before being summed up.

13. The method according to claim 6, wherein sums are rebased by adding high order bits to a next higher radix limb when too many carry bits are accumulated.

14. The method according to claim 13, wherein rebasing the sums is combined with addition and/or reduction operations.

15. The method according to claim 9, wherein at least one of the one or more partial products are scaled by a factor of two.

16. A computer implemented method of multiplying two wide-word integer values represented in a non-Reduced-Radix Representation, wherein successive subsets of bits of a binary representation of a wide integer are stored in different source vector registers, the method comprising:
multiplying all words of the first integer value obtained from a first source vector register with corresponding words of the second integer value obtained from a second source vector register to create one or more partial products;
shifting the one or more of the partial products to align a radix value;
adding the shifted partial products to a result;
storing the result, the result being up to two vector registers wide, in two target vector registers;
performing all of the above steps by one instruction or by two instructions, a first instruction to store a first part of the result in a first target vector register and a second instruction to store a second part of the result in a second target vector register.

17. The method according to claim 16, further comprising:
multiplying all words of the first integer value obtained from the first source vector register with a corresponding word of the second integer value obtained from the second source vector register to create the one or more partial products;
shifting the one or more of the partial products to align the radix value;
adding the shifted partial products to the result;
storing the result, the result being up to two vector registers wide, in two target vector registers;
performing all of the above steps by one instruction or by two instructions, the first instruction to store the first part of the result in the first target vector register and the second instruction to store the second part of the result in the second target vector register.

18. The method according to claim 16, wherein an addend for adding to the product of the two wide-word integer values is enabled by an immediate bit.

19. A computer hardware circuit for execution of at least one instruction for performing the method of multiplying two wide-word integer values represented in a Reduced-Radix Representation using a Redundant Number System arithmetic, at least comprising
source vector registers for input of the two wide-word integer values and an addend,
two multiplier units adapted for computation of at least two partial products,
two adder units adapted for adding the partial products and the addend,
four multiplexer units adapted for implementing shifts of partial sums and the addend,
two adder units adapted for computing a partial sum,
a target vector register for storing the partial sum.

20. The computer hardware circuit according to claim 19, wherein the computation of the partial products and the addition of the addend is split into high parts and low parts.

21. The computer hardware circuit according to claim 19, wherein two multiplexer units of the four multiplexer units for shifting the addend are fed by a low addend part of the addend and a high addend part of the addend, the two multiplexer units being coupled to the two adder units and
the other two multiplexer units of the four multiplexer units are coupled between the two adder units for adding the partial products and the addend and the two adder units for computing the sum.

22. A computer hardware circuit for execution of at least one instruction for performing the method of multiplying two wide-word integer values represented in a non-Reduced-Radix Representation, at least comprising
source vector registers for input of the two wide-word integer values and an addend,
two multiplier units adapted for computation of at least two partial products,
two adder units for adding the partial products and the addend,
a multiplexer unit adapted for selecting a first part of the result,
two adder units adapted for computing the result and carry bits,
a gating function and a multiplexer unit adapted for selecting the result and carry bits,
a target vector register for storing the result.

23. The computer hardware circuit according to claim 22, wherein the computation of the partial products and the addition of the addend is split into high parts and low parts.

24. The computer hardware circuit according to claim 22, wherein the gating function and the multiplexer for selecting the result and carry bits are coupled between the two adder units for computing the result and carry bits and a target vector register.
